(19) United States
(12) Patent Application Publication
(10) Pub. No.: US 2009/0119177 A1
(43) Pub. Date: May 7, 2009

(54) Outdoor and out of home advertising method and system

(76) Inventors: Thomas K. John, Irving, TX (US); Arun Jeyam, Carrollton, TX (US); Narendra Nallapareddy, Plano, TX (US); Ramammorthy Krishnaswamy, Plano, TX (US)

Correspondence Address: Akula& Associates, P.C.;Suite 225, 1303 W. Walnut Hill Lane, Irving, TX, 75038, US

(21) Appl. No.: 12/290,542

(22) Filed: Nov. 1, 2008

Related U.S. Application Data
(60) Provisional application No. 61/001,888, filed on Nov. 5, 2007.

(51) Int. Cl. G06Q 30/00; G06Q 10/00; G06F 17/30; G06Q 90/00

(52) U.S. Cl. 705/14; 705/27; 705/26; 705/1

(57) ABSTRACT

Disclosed is an outdoor and out of home advertising (OOHA) method and system having at least one kiosk client coupled to a secured central server via a VPN, internet, radio communication, satellite communication, Bluetooth communication, or any communication, said at least one kiosk client and secured central server further coupled to the networking. The kiosk client connected to secure central server dynamically pushes specific advertisement based upon user profile, location of the kiosk client, creates user profile preferences, and uploads proactive applications for secured communication.

### CROSS REFERENCE TO RELATED APPLICATION

This application claims the benefit of provisional patent application Ser. No. 61/001,888 filed on Nov. 5, 2007 by the present inventors.

### FIELD OF THE INVENTION

The present invention relates to outdoor and out of home advertising channels, using one or more kiosk client coupled to one or more secured central server via a virtual private network (VPN), internet or a communication network, said one or more kiosk client and secured central server further coupled to the Internet. The present invention is further referred to as an outdoor and out of home advertising (OOHA) system. KIOSK client is open platform which allows adding any application, services or devices and such applications and services are controlled by secured central server. The present invention also relates to dynamic targeted advertisements determined by the secured central server by using any one of or in combination of kiosk client location, user preferences, current user behavior, and past user behavior.

### BACKGROUND

Public Internet access points or clients are well known in the art. These clients typically comprise a computer network having loaded thereon a web browser that facilitates access to Internet resources after logging in through a web page of the client or an access service provider. However, such conventional Internet access points are not controlled by a secured central server. What is desired is at least one or more kiosk clients that are able to accessed at home or at public places, and be served with a variety of media and services, including Internet access, as directed or monitored by a secured central server via a VPN, internet or a communication network. The present invention solves the problem of not allowing a user to quickly access the internet without subscribing to long term contracts. By allowing the user to access the internet at home or at a public place for free, the invention solves the problem by allowing a more comfortable, secure and enjoyable environment for the user to surf the internet without being bound to a long term contract.

### SUMMARY OF THE INVENTION

The present invention is an outdoor and out of home advertising (OOHA) system, comprising one or more of a secured central server, and one or more kiosk clients coupled directly or indirectly to one or more the secured central server via a VPN, internet or a communication network. In addition, the secured central server configured to comprise an outdoor and out of home advertising kiosk management system serving as a communication gateway for communicating with said one or more kiosk clients, an outdoor and out of home advertising kiosk back office application capable of performing data management functions for said one or more kiosk clients, and an outdoor and out of home advertising kiosk back office management system serving as a data transfer gateway for outdoor. KIOSK client are capable to connect hardware devices such as printers, phones etc. The KIOSK client is secured browser which controls all spam, porn, blocks pop-ups, etc.

### DESCRIPTION OF THE DRAWINGS

A more complete understanding of the present invention may be obtained by reference to the following Detailed Description, when taken in conjunction with the accompanying Drawings, wherein:

FIG. 1 is an overview of the system of the present invention

FIG. 2 is an illustration of a secured central server showing software applications installed thereon in accordance with the present invention;

FIG. 3 is an illustration of the physical components of a kiosk in the present invention

FIG. 4 is an illustration of the software components installed on a kiosk client of the present invention;

FIG. 5 is a flow chart illustrating the steps of the OOHA browser process in accordance with the present invention;

FIG. 6 is a flow chart illustrating the steps of the OOHA local disk cleaner process in accordance with the present invention;

FIG. 7 is a flow chart illustrating the steps of the OOHA downloader process in accordance with the present invention;

FIG. 8 is a flow chart illustrating the steps of the OOHA installer process in accordance with the present invention;

FIG. 9 is a flow chart illustrating the steps of the OOHA dynamic updater sub-process in accordance with the present invention;

FIG. 10 is a flow chart illustrating the steps of the OOHA player process in accordance with the present invention;

FIG. 11 is a flow chart illustrating the steps of the OOHA up-loader process in accordance with the present invention;

FIG. 12 is a flow chart illustrating the steps of the OOHA watch dog install check sub-process in accordance with the present invention; and

FIG. 13 is a flow chart illustrating the steps of the OOHA watch dog process in accordance with the present invention.

FIG. 14 is a flow chart illustrating the steps of creating new business partner information and adds advertisement.

FIG. 15 is a flow chart illustrating the steps of pushing media files to kiosk client.

FIG. 16 is a flowchart illustrating the steps of deploying the Business Partner's Applications and services on to the Kiosk client.

### DETAILED DESCRIPTION

The present invention will now be described more fully with reference to the accompanying drawings and flow charts, in which preferred embodiments of the present invention are shown. The present invention may, however, be embodied in many different forms and should not be constructed as limited to the embodiments set forth herein; rather, these embodiments are provided so that this disclosure will be thorough and complete, and will fully convey the scope of the present invention to those skilled in the art.

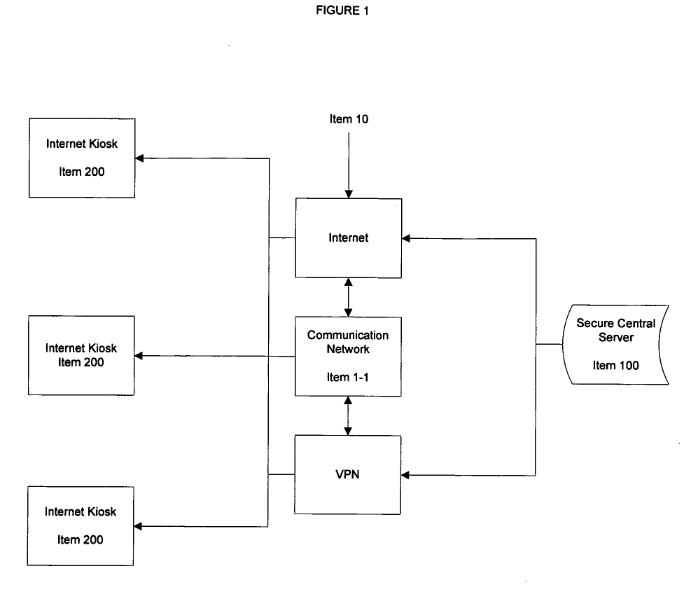

FIG. 1 is an overview of the OOHA system of the present invention. As seen therein is a plurality of networked kiosk clients, item 200, that are able to access, and be served, a variety of media and services, including Internet access, as directed or monitored by a secured central server via a VPN, internet, or communication network.

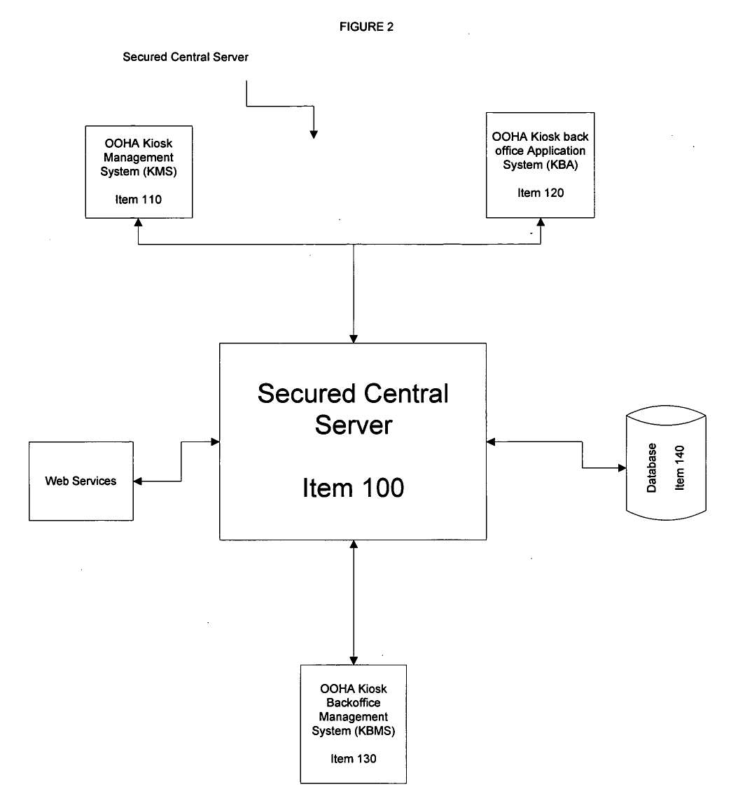

FIG. 2 is an illustration of a secured central server showing software applications installed thereon in accordance with the present invention. As seen therein is an overview of the OOHA kiosk management system (KMS) of the present invention, the OOHA kiosk back office management system (KBMS) of the present invention and the OOHA kiosk back office application (KBA) of the present invention.

The KMS is a web based application deployed on the central server that is used as a communication gateway by all the kiosk clients. KMS performs or facilitates the following services at the kiosk client: The KMS is adapted to obtain the Globally Unique Identifier (GUID) of the kiosk client, and receive and then transmit activation information, such as user name or password, or other identifying information entered via keystroke, media card, biometric identification or the like. If the activation information is validated, the KMS activates the kiosk client. The KMS is adapted to cause the kiosk client to transmit to the central server, via a VPN, internet, or communication network, condition information periodically. KMS is adapted to cause the central server to receive and save the kiosk client condition information. The KMS is adapted to cause the kiosk client to receive from the central server KMS configuration information that can be changed dynamically. The KMS is adapted to cause each kiosk client to receive media day schedule mapping information from the centralized server via the VPN, internet or communication network. The schedule from the central server is adapted to direct each kiosk client the media to be played and when it is to be played. The KMS is adapted to cause each kiosk client to receive and download media files from the central server via the VPN, internet, or communication network. The KMS is adapted to cause each kiosk client to access the central server database via its secure Uniform Resources Locator (URL). The URL is initially obtained from the central server. The KMS is adapted to cause a kiosk client to receive new URL requests from a user. The central server returns the website associated with the URL, if it is known. The KMS is adapted to cause each kiosk client to receive from the central server an installation file download, from time to time, as a new code base is ready. The KMS is adapted to cause each kiosk client to poll the central server for commands such as restart, shutdown, and force commands. The KMS is adapted to cause each kiosk client to receive administration credentials for authorization; whereupon, the KMS is adapted to cause the central server to check and return to allow or deny an authorization. The KMS is adapted to cause each kiosk client to display user registration information for new user creation. The KMS is adapted to cause each kiosk client to post user credentials for authorization. The central server is adapted to stream authorization information and user session information. The KMS is adapted to cause each kiosk client to receive and transmit a session extension request. The central server then validates and returns session increment.

The KBMS is a web based application deployed on the central server and used as data transfer gateway for KBA. This web layer uses KMS for report generation and notification. This layer provides certain key services for KBA. The KBA is adapted to interface with KBMS to add, delete, and modify kiosk client information by facilitating kiosk client asset management. The KBA is adapted to interface with KBMS to create locations and assign kiosk clients to locations, facilitating kiosk location management. The KBA is adapted to interface with KBMS to activate each kiosk client after the kiosk client is shipped and installed. The KBA is adapted to interface with KBMS to assign maintenance vendor and configure support information, facilitating kiosk client maintenance management. The KBA is adapted to interface with KBMS to create OOHA vendors, facilitation kiosk client vendor management. The KBA is adapted to interface with KBMS to create contacts for various entities, facilitating kiosk client contact management. The KBA is adapted to interface with KBMS to create advertising contracts for kiosk clients, facilitating artwork upload and kiosk client advertising contract management. The KBA is adapted to interface with KBMS to create invoices for advertising contracts in conjunction with a kiosk client billing system. The KBMS is adapted to generate a variety of reports, such as those related to kiosk client condition, kiosk client contracts, kiosk client maintenance schedules, and the like. KBMS further includes a standalone service adapted to send notifications to users. The KBA is adapted to interface with KBMS to create, delete, append, and activate/inactive users. The KBA is adapted to interface with KBMS to facilitate user login.

As noted above, the KBA is a standalone application deployed on the central server that interfaces with KBMS to perform certain key functions. The KBA performs a kiosk client asset management, kiosk client location management, kiosk client activation, kiosk client maintenance management, kiosk client vendor management, kiosk client contact management, kiosk client advertising contract management, kiosk client advertising billing functions, report generation and display, kiosk client notification, and user login. Furthermore, the user preference is used to track the user profile. The tracking is done by logging each URL the user is going to and the number of times the user frequently goes to that URL. In addition, any services used by the user on the Kiosk client are also tracked and logged. These three (3) components are adapted to facilitate the delivery of dynamic targeted advertising from the central secured server to the kiosk client.

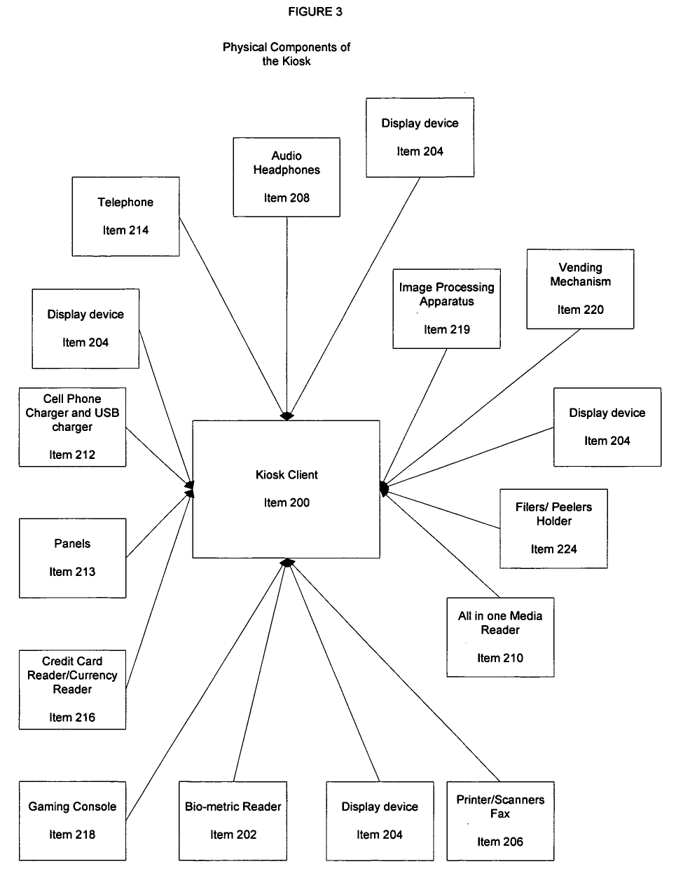

FIG. 3 is an illustration of the physical components of a kiosk client of the present invention. As seen therein, the kiosk client of the present invention is adapted to receive a variety of inputs via a user through a variety of user input devices and output a variety of media for the benefit of the user and those surrounding the kiosk client. The kiosk client is networked to a central server via a VPN, internet or a communication network so as to validate a user using a user identification means, including, but not limited to, key inputted username/password, biometric identification such as retina scan or fingerprint scan, media card swipe or proximity sensor. A variety of outputs are made available at the kiosk client at public places, including display means, such as a television monitor, LCD screen and the like (each having an audible output means, such as a speaker, headphones, ear buds or output jack) to output advertising thereon which has been delivered to the kiosk client for display on the display means from either the secured central server, or from the VPN, Internet or communication network as directed by, or tunneled through, the secured central server to the kiosk client using an appropriate networking or transmission protocol, or wireless medium and a printer/facsimile/scanner input/output. The kiosk client further includes a monitor means, with accompanying audible output means, for displaying media received over a web browser application running on a processor of the kiosk client. Further input means includes an all in one media reader to accept, inter alia, SD cards, and thumb drives. The kiosk client at public places further includes a cell phone charger and USB charger, a telephone with a connection to either the wireless infrastructure or to the public switched telephone network, a credit card and currency reader/input means, gaming console and Image processing apparatus. The kiosk client further includes a vending mechanism to accept and dispense items, such a phone cards, mechanical means for holding advertising panels, fliers and peelers. The physical components of the kiosk client are directed to displaying dynamic targeted advertising through both the display means and monitor means. The monitor means are displayed entire around the kiosk client, and on top of the kiosk client. The credit card input mechanism is adapted to permit a user to pay membership fees to access resources of the OOHA system.

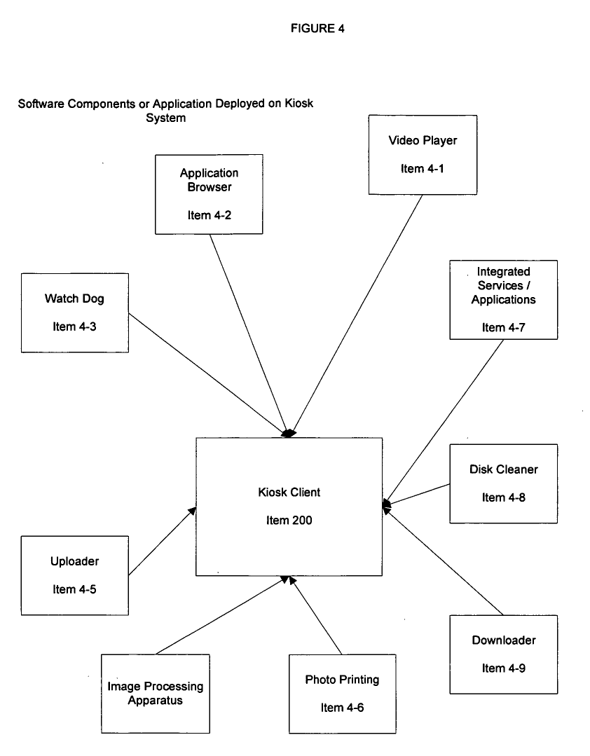

FIG. 4 is an illustration of the software components installed on a kiosk client of the present invention. Such software components include but are not limited to a video player, ticket reservation application, photo printing application. Each of the foregoing software applications is coupled to a device appropriate for the software application. For example, the photo printing application has device drivers and is coupled to the printer mechanism of the kiosk client. Further software applications, as described below, an OOHA browser application, OOHA local disk cleaner, OOHA downloader, OOHA installer, OOHA dynamic updater, OOHA player, OOHA up-loader, and OOHA watch dog.

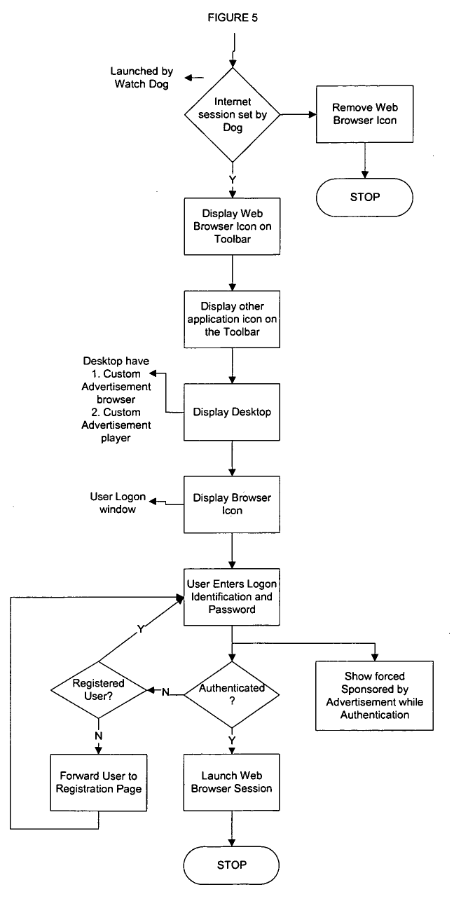

FIG. 5 is a flow chart illustrating the steps of the OOHA browser process in accordance with the present invention. The OOHA browser sits on top of the operating system and is the only gateway for a user to communicate through all other applications. The OOHA browser, preferably has three (3) components, the toolbar, desktop, and login window. Application icons, such as a web browser, chat window, Music, Webcam and the like are displayed on the toolbar. These icons are dynamically enabled and/or disabled based on the user authorizations that have been stored in the central server and transmitted to the kiosk client at user authorization and validation. The desktop window preferably has a custom browser adapted to display HTML content, such as surveys and advertising content and a custom media player adapted to stream and play advertisements.

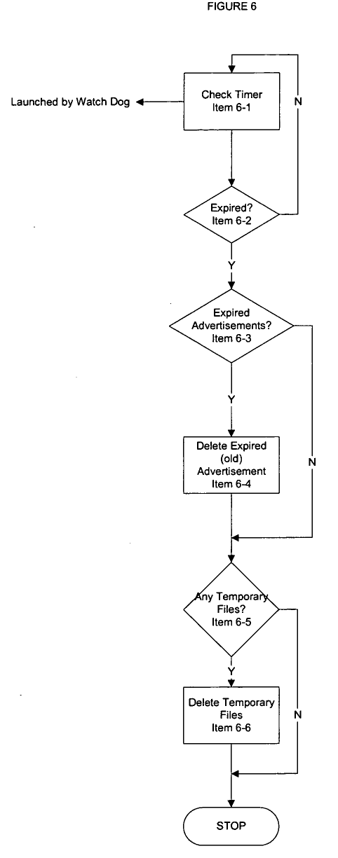

FIG. 6 is a flow chart illustrating the steps of the OOHA local disk cleaner process in accordance with the present invention. The OOHA disk cleaner is launched by an OOHA watch dog. The OOHA local disk cleaner is adapted to periodically delete stale data and temporary files from a kiosk client's local disk. Pseudo code for performing this functionality may be as follows:

Read media in from database

If expired media then

Delete expired media

End if

Read local disk file system

If temp files exist then

Delete temp files

End if

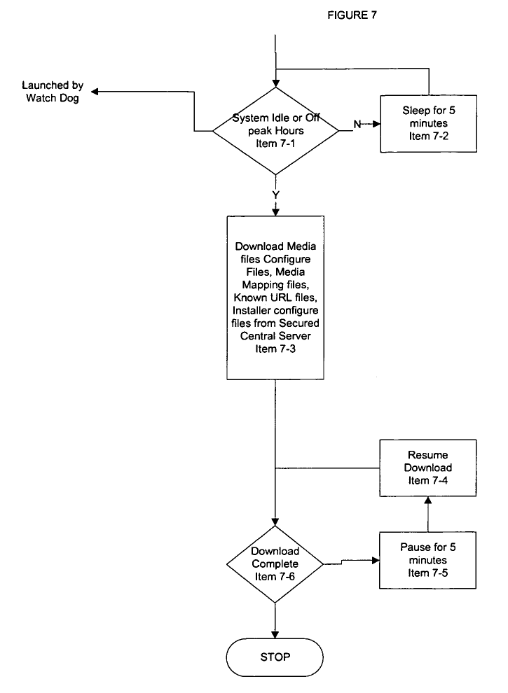

FIG. 7 is a flow chart illustrating the steps of the OOHA downloader process in accordance with the present invention. The OOHA downloader is launched by the OOHA watch dog. The OOHA downloader is adapted to periodically download kiosk client specific information from the central server. Such specific information includes, but is not limited to, media files, configuration files, media files, mappings, known URL files, installer files, and installer specific files which are downloaded when a session is idle or during off peak hours, as determined by an administrator. Pseudo code for performing this functionality may be as follows:

Downloader tries to establish connection with central server,

If successful then

download files and configuration data

If Connection broken

Pause and resume later

End if

Else

Re-try later

End if

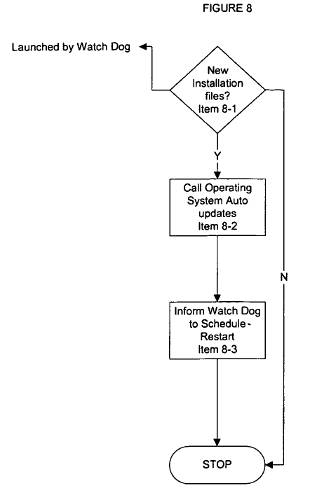

FIG. 8 is a flow chart illustrating the steps of the OOHA installer process in accordance with the present invention. The OOHA installer is launched by the OOHA watch dog program. The installer installs any software patches or fixes. Pseudo code for performing this functionality may be as follows:

Check for new files

If found then

Call operating system automatic updater or Call scheduled task

Inform Dog program to schedule a re-start

End if

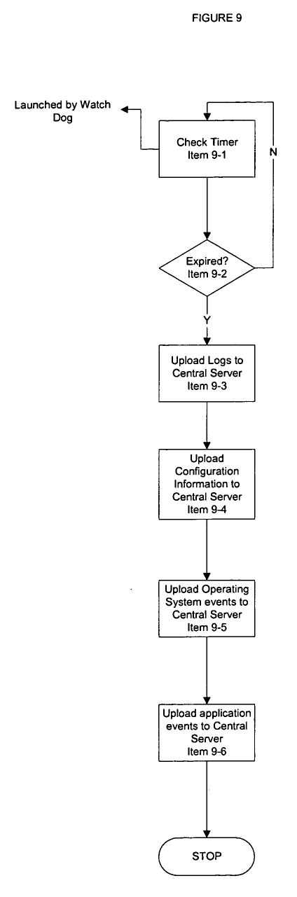

FIG. 9 is a flow chart illustrating the steps of the OOHA dynamic updater sub-process in accordance with the present invention.

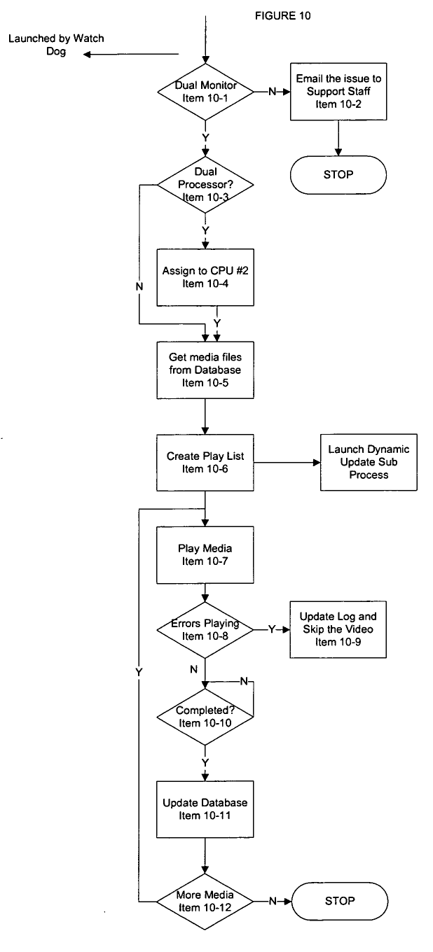

FIG. 10 is a flow chart illustrating the steps of the OOHA player application in accordance with the present invention. The OOHA player application is launched and monitored by the OOHA watch dog application. The OOHA player application is adapted to generate and store a play list from the database and play the media primarily on the display means, or alternatively, on a monitor of the kiosk client. The generation of the media play list is preferably based on a variety of parameters, including demographics of the user, location of the kiosk client, rotation schedules for advertising, and user behavior. The OOHA player application is launched and assigned by the OOHA watch dog application. The OOHA player application is also continuously monitored by the OOHA watch dog application. During the invocation process, the OOHA player application looks for “dual monitor” to determine if there is a display means with the kiosk client in addition to a monitor means. If a display means is not available, it will quit the execution. The OOHA player application is responsible for reading media information from a local or remote (e.g., the central server) database each day (or other appropriate period of time) so as to generate and store on a memory, a play list. The memory may be a hard drive, or other random access, EEPROM or similar volatile or non-volatile memory. Thereafter, the OOHA player application is adapted to load each media file of the play list from memory and play the media on the appropriate display means or monitor means. After playing the media, the OOHA player application is adapted to update the media played flag to true in a local or remote database. If any errors are encountered during the playback of a media file, the OOHA player application is adapted to skip the corrupted or defective media and continue to the next media file in the play list. The OOHA player application is further adapted to launch a dynamic updater process. The dynamic updater process is part of the OOHA player application but is launched as a new, separate thread. The dynamic updater process queries a local or remote database for new media updates. If there are any new media updates, certain functionality may be performed, as illustrated by the following pseudo-code:

Add to the existing play list
Else

Create new play list

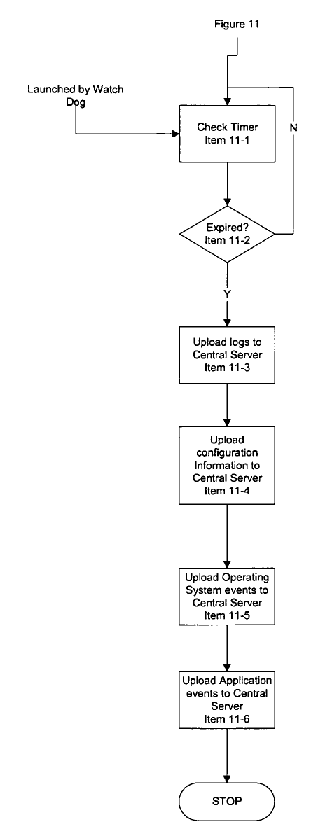

FIG. 11 is a flow chart illustrating the steps of the OOHA up-loader process in accordance with the present invention. The OOHA up-loader is launched by the OOHA watch dog application. The OOHA up-loader is adapted to periodically upload logs, configuration data, application events, operating system events and any other client information from a kiosk client to the central server. Pseudo code for performing this functionality may be as follows:

Up-loader tries to establish connection with central server,
If successful then

Upload files and configuration data

Else

Re-try later

End if

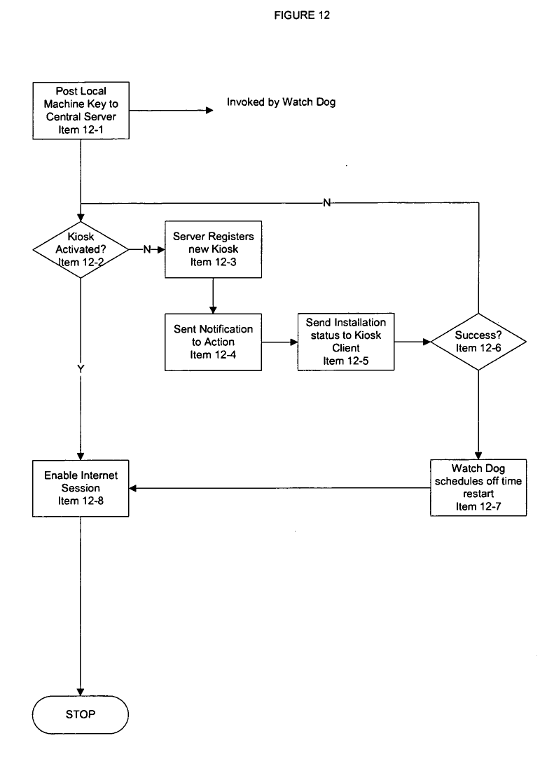

FIG. 12 is a flow chart illustrating the steps of the OOHA watch dog install check sub-process in accordance with the present invention.

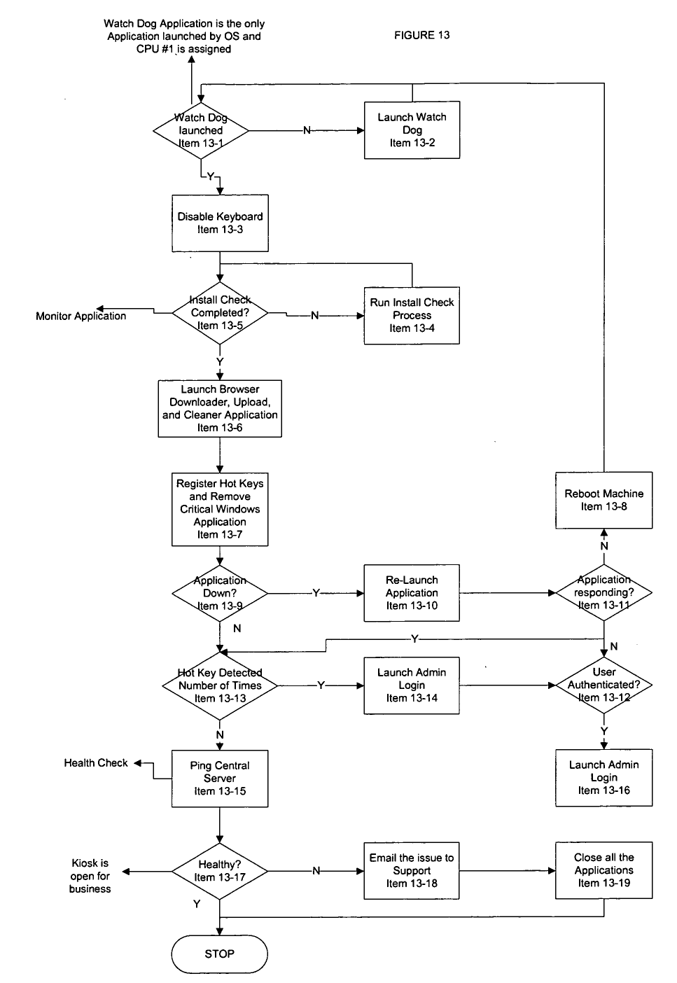

FIG. 13 is a flow chart illustrating the steps of the OOHA watch dog process in accordance with the present invention. The OOHA watch dog application is launched by the kiosk client operating system as bootstrap process. The OOHA watch dog application performs the installation check, and launches and monitors all applications running on the kiosk client. The OOHA watch dog application is also responsible for performing the condition status check of all applications, processes, connectivity and handshake with central server. More specifically, during the bootstrap process, the operating system [of the kiosk client] launches the OOHA watch dog application and assigns the execution process to [CPU #2]. The OOHA watch dog application, upon invocation, disables all the user keys on the keyboard to block the user intervention during the booting process and executes the following installation checks as illustrated using pseudo code:

Derive local machine key from BIOS GUID, Network GUID and
MAC ID. Post the local machine key to central server to check,
if the kiosk client is activated.

If activated then

Enable the flag to launch the application browser

Else

Register the kiosk with central server and send the email

notification to administrator

The installation check is adapted to be performed randomly to ensure that the kiosk client is its place. This will help prevent communication to/from vandalized kiosks. The following applications may then be launched: application browser; downloader; up-loader; disk cleaner; player; installer and all hot keys registered and critical window processes removed. The OOHA watch dog application is further adapted to continuously monitor all the applications, and re-launch applications, if one or more applications are down. Preferably, if one or more applications do not respond to the re-launch a pre-determined number of times, the OOHA watch dog application can cause the kiosk client to reboot. Even with the reboot, if the applications do not respond, then the OOHA watch dog application can close all the applications and send a notification email to support staff.

The OOHA watch dog application is further adapted to detect hot keys. Specifically, if the same hotkey combination is detected more than a predetermined number of times, the OOHA watch dog application can launch an administration logon page adapted to permit a user to enter credentials, such as a user name and password, or authentication. If the user is authenticated, then user is forwarded to an administration page otherwise an error page is displayed.

The OOHA watch dog application is further adapted to perform condition checks. Specifically, it can ping the central server and transmit the kiosk client's condition information, including application status, VPN, internet, or communication network connectivity status, audit trail, system shutdown logs and similar information.

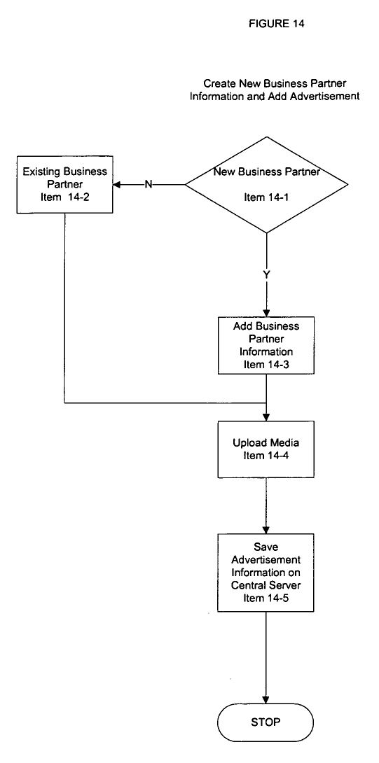

In FIG. 14, the OOHA system allows on the server side to add new perspective business clients. The purpose of adding new business clients to the system creates new advertisements for the kiosk client. The new media allows the system to create a dynamic advertisement based on the user profile. The new business partners are first determined, item 14-1, by the administrator. If the system determines that it is a new business partner, the system adds the business partner to the server with all information about the partner. The information of the new business partner can be the name of business and the type of business the partner is affiliated to, as demonstrated in item 14-3. Thereafter, all the media that the new business partner provides will be uploaded to the system and stored in the database of the secure central server, as demonstrated in item 14-5. This process creates variety pool of advertisements that the system can push on the kiosk client based on user profile.

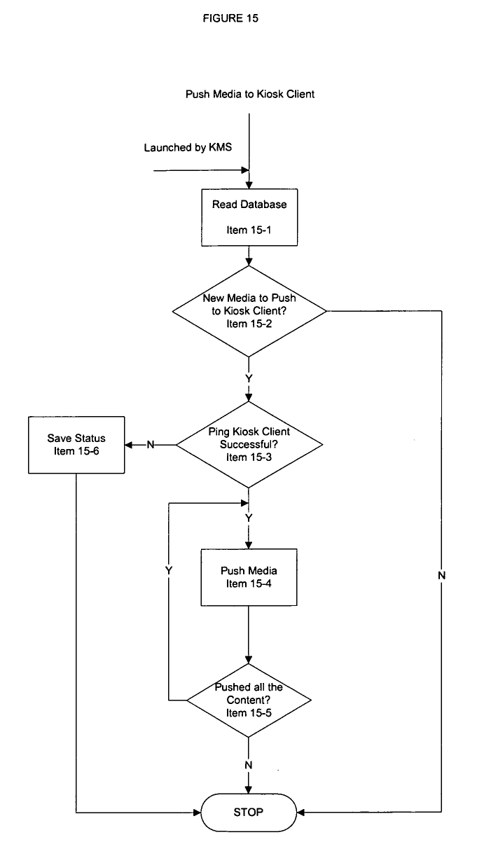

FIG. 15 illustrates the method on how the media from secure central server is pushed on the kiosk client. The system contains a plurality of databases, which stores all of the new business partner's uploaded media. There can be a plurality of databases that can store multiple media files for various business partners. The pushing of the media is done after the KMS is launched by the kiosk client system. When the user logs in, the system, item 15-1, will read the database to determine which media files will be pushed to kiosk client. Next, the system will see if there are new media files that need to be pushed on the kiosk client. If no new media files are stored in the databases, the system will not push the media to the kiosk client, as illustrated in item 15-2. However, after a new business partner is added, as illustrated in FIG. 14, the secure central server will determine which new media must be pushed, item 15-2. The initial pushing is done by the secure central server pinging the kiosk client, item 15-3. Once the kiosk client is successfully pinged, the system will commence with pushing the media onto the kiosk client, item 15-4. The system will determine if all the media has been pushed. This method has been used when the media data is broken up into segments or there are multiple media data for a business client. The system will check to determine all segments have been pushed to the kiosk client, as well as all new media data. After the system has successfully pushed all the media to the kiosk client the system will bring to a standstill until more new media data needs to be pushed.

Next, if the system has to push new media to the kiosk client, as illustrated in item 15-2, and the system were to fail with pinging the kiosk client. The system, item 15-6, will save the status of the media data as being pushed or needs to be pushed. Thereafter, the system will bring to a halt the pushing of media to the kiosk client.

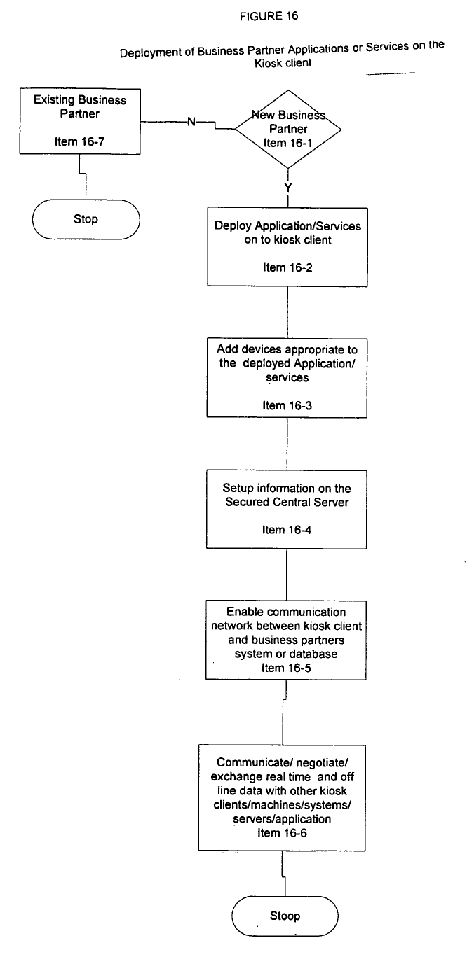

FIG. 16 illustrates the method of deploying the Business Partner's applications and services on to the kiosk client. Kiosk client application is open platform to easily host, deploy, interact and integrate with any business partner or third party applications or services. These applications or services can be seamlessly accessed from the kiosk client. The kiosk clients can communicate/negotiate/exchange real time and off line data with other kiosk clients/machines/systems/servers/applications. For example price check, inventory, appointment scheduling, ticket reservation, coupons, security information, logs, audit trail, promotional offers, etc.

The new business partners are first determined, item 16-1, by the administrator. If the system determines that it is a new business partner, applications or any services offered by the business partner are deployed on to the kiosk client, as demonstrated in item 16-2. After successfully deploying the applications or the services devices which are appropriate to such applications or services are added to the kiosk client, as demonstrated in item 16-3. Thereafter, such information is setup on the secured central server, as demonstrated in item 16-4. Subsequently, VPN, internet or a communication network is enabled between the kiosk client and the business partner's systems or databases for data transfer or exchange, as demonstrated by item 16-5. At that point the kiosk client is able to integrate ort interact with the business partner's system or databases according to item 16-6. This process enables the kiosk client to interact directly with the business partner's systems or databases without the involvement of the secured central server. An example for such a process is if the business partner is a new Healthcare provider, by going through this process, a user who is accessing the kiosk client will be able to schedule appointments or utilize any other services provided by the business partner. Even though the access is through the kiosk client the business partner's system or database will reflect any such appointments made through the kiosk client because of the communication network enables between the kiosk client and the business partner's system or database.

The embodiments shown and described above are only exemplary. Even though numerous characteristics and advantages of the preferred embodiment of the present invention have been set forth in the foregoing description together with details of the invention, the disclosure is illustrative only and changes may be made within the principles of the invention to the full extent indicated by the broad general meaning of the terms used in the attached claims.

We claim:

1. An outdoor and out of home advertising (OOHA) system, comprising:
one or more of a secured central server;
one or more kiosk clients coupled directly or indirectly to one or more said secured central server via a virtual private network (VPN),internet, or communication network; and
wherein said secured central server configured to comprise an outdoor and out of home advertising kiosk management system serving as a communication gateway for communicating with said one or more kiosk clients,
an outdoor and out of home advertising kiosk back office application capable of performing data management functions for said one or more kiosk clients, and
an outdoor and out of home advertising kiosk back office management system serving as a data transfer gateway for outdoor and out of home advertising kiosk back office application
wherein the kiosk client provides secured internet access and integrated services to users while displaying dynamic targeted advertisements, promotional offers and community related messages like alerts or any other emergency messages.

2. The outdoor and out of home advertising system of claim 1, wherein said one or more secure central server determines a dynamic targeted advertisement by using any one of or in combination of kiosk client asset management, kiosk client location management, kiosk client activation, kiosk client maintenance management, kiosk client vendor management, kiosk client contact management, kiosk client advertising contract management, kiosk client advertising billing functions, report generation and display, kiosk client notification, user preferences, user demographics, time, current user behavior, or past user behavior.

3. The outdoor and out of home advertising system of claim 2, wherein said dynamic targeted advertisement directed to display on one or more kiosk clients a displays means or a monitor means.

4. The outdoor and out of home advertising system of claim 3, wherein said display means or said monitor means is located entirely around and on top of a kiosk client,
wherein, said display means or said monitor means includes any of form of advertising on a LCD screen, a flat screen, a plasma screen, or an electronic display system.

5. The outdoor and out of home advertising system of claim 1, wherein said one or more kiosk clients comprising of a computer, hand held, a media device, a display medium a point of sale terminal, an internet enabled phone, home appliance device and not limiting to any one more of this combinations which could be coupled with a VPN, internet or communication network.

6. The outdoor and out of home advertising system of claim 1 wherein the said central secured server controls all the dynamic targeted advertisements slots and spaces on the said display or said monitor means of the kiosk client.

7. The outdoor and out of home advertising system of claim 1, wherein said one or more kiosk clients display on the said display means or said monitor means a plurality media files loaded into a memory of said kiosk clients from either one or more said secured central server or from an Internet, as directed by said secured central server
wherein said plurality media files are obtained based on a play list generated by one or more of said secured central server.

8. The outdoor and out of home advertising system of claim 8, wherein the play list is generated based on a variety of parameters, including user demographics, kiosk client location, time, date, other outside events, user current activity, or user past activity.

9. The outdoor and out of home advertising system of claim 1,
Wherein kiosk client is an open platform to host, deploy, interact and integrate with business partner services and applications and each such integrated services and applications is coupled to a device appropriate for the said integrated services and application;
Wherein the said integrated services and applications are deployed on to the kiosk client from the business partner's system and databases; and
a VPN, internet or communication network is enabled between kiosk clients, machines, system and to communicate or negotiate or exchange or transfer real time and off line data.

10. The outdoor and out of home advertising system of claim 2, wherein said one or more secure central server has determined the authentication of login of user then said one or more secure central server will push a media data to said one or more kiosk clients.

11. The outdoor and out of home advertising system of claim 10, wherein said one or more secure central server will push all new said media data to said one or more kiosk clients.

12. A method of providing outdoor and out of home advertising (OOHA), comprising the steps of:
providing one or more of a secured central server;
providing one or more kiosk clients;
coupling directly or indirectly one or more kiosk clients to one or more of said secured central server via a virtual private network (VPN), internet or communication network;
serving an outdoor and out of home advertising kiosk client via a database; and controlling said one or more kiosk clients by one or more of said secured central server via commands sent over the VPN, internet or communication network;
wherein one or more of said secured central server comprises an outdoor and out of home advertising kiosk management system serving as a communication gateway for communicating with said one or more kiosk clients, further comprising an outdoor and out of home advertising kiosk back office application capable of performing data management functions for the at least one kiosk client, and an outdoor and out of home advertising kiosk back office management system serving as a data transfer gateway for outdoor and out of home advertising kiosk back office application.
wherein the kiosk client provides secured internet access and integrated services to users while displaying dynamic targeted advertisements, promotional offers and community related messages like alerts or any other emergency messages.

13. The method of claim 12, further comprising
determining a dynamic targeted advertisement by using any one of or in combination of kiosk client asset management, kiosk client location management, kiosk client activation, kiosk client maintenance management, kiosk client vendor management, kiosk client contact management, kiosk client advertising contract management, kiosk client advertising billing functions, report generation and display, kiosk client notification, user preferences, user demographics, time, current user behavior, or past user behavior.

14. The method of claim 13, further comprising:
directing to display said dynamic targeted advertisement on one or more kiosk clients a displays means or a monitor means.

15. The method of claim 14, further comprising:
controlling all the dynamic targeted advertisements slots and spaces on the said display means or said monitor means of the kiosk client.

16. The method of claim 14, further comprising:
loading media files into a memory of said one or more kiosk clients from either the secured central server or from an Internet, as directed by the secured central server and displaying on the said display means or monitor means.

17. The method of claim 16, further comprising:
obtaining the media files based on a play list generated by one or more said secured central server.

18. The method of claim 17, further comprising generating based on a variety of parameters, including user demographics, kiosk client location, user behavior, time, date, or other outside events.

19. The method of claim 12, further comprising:
providing user access to the resources of the outdoor and out of home advertising
system based on the receipt and validation of certain parameters,
wherein the targeted advertisements are showed to user while authorizing the access based on the location, type of facility or previously collected user data.

20. The method of claim 19, wherein one or more kiosk clients are comprising any one of a computer, a handheld, a point of sale terminal, an internet enabled phone, or home appliance device.

21. A method of providing outdoor and out of home advertising (OOHA), comprising the steps of:
providing one or more of a secured central server;
providing one or more kiosk clients;
coupling directly or indirectly one or more kiosk clients to one or more of said secured central server via a virtual private network (VPN), internet or communication network;
serving an outdoor and out of home advertising kiosk client via a database; and
controlling said one or more kiosk clients by one or more of said secured central server via commands sent over the VPN, internet or communication network;
wherein one or more of said secured central server comprises an outdoor and out of home advertising kiosk management system serving as a communication gateway for communicating with said one or more kiosk clients, further comprising an outdoor and out of home advertising kiosk back office application capable of performing data management functions for the at least one kiosk client, and an outdoor and out of home advertising kiosk back office management system serving as a data transfer gateway for outdoor and out of home advertising kiosk back office application,
wherein the kiosk client provides secured internet access and integrated services to users while displaying dynamic targeted advertisements, promotional offers and community related messages like alerts or any other emergency messages;
adding a new business partner to said one or more secure central server
wherein, new business partner uploads a media data to one or more secure central server;
pushing all said media data to said one or more kiosk clients from said one or more secure central server; and
determining a dynamic targeted advertisement by using any one of or in combination of kiosk client asset management, kiosk client location management, kiosk client activation, kiosk client maintenance management, kiosk client vendor management, kiosk client contact management, kiosk client advertising contract management, kiosk client advertising billing functions, report generation and display, kiosk client notification, user preferences, user demographics, time, current user behavior, or past user behavior.

22. The method of claim 21 further comprising of the one or more said secured central server pushes emergency alerts to one or more said kiosk clients in real time.
